(19) United States
(12) Patent Application Publication
(10) Pub. No.: US 2025/0128680 A1
(43) Pub. Date: Apr. 24, 2025

(54) METHOD FOR CHANGING A VERTICAL LIFTED-OUT STATE

(71) Applicant: Palfinger AG, Bergheim bei Salzburg (AT)

(72) Inventors: Boban PETRONIJEVIC, Hallwang (AT); Benjamin JUDS, Salzburg (AT); Werner EMMINGER, Lochen (AT); Friedrich GSCHAIDER, Lamprechtshausen (AT)

(21) Appl. No.: 18/982,525

(22) Filed: Dec. 16, 2024

Related U.S. Application Data
(63) Continuation of application No. PCT/AT2023/060186, filed on Jun. 13, 2023.

(30) Foreign Application Priority Data
Jun. 17, 2022 (AT) GM 50099/2022

(51) Int. Cl. B60S 9/12

(52) U.S. Cl. CPC B60S 9/12

(57) ABSTRACT

A method for changing a vertical lifted-out state of a carrier vehicle parked on a ground surface, for a lifting device having a supporting system with support legs and a controller for controlling drives of the support legs. The method including calculating a sequence of control commands for sequential and time-limited control of the drives for changing the vertical lifted-out state while maintaining the instantaneous inclination of the carrier vehicle and/or the lifting device within a predetermined range for an inclination deviation. A lift-out step includes control of the drives of the support legs of the supporting system with the sequence of control commands for changing the vertical lifted-out state of the carrier vehicle and/or the lifting device relative to the ground surface. A sequential and time-limited control of the drives of the support legs of the supporting system with control pulses occurs with the sequence of control commands.

### BACKGROUND OF THE INVENTION

The present invention relates to a method for changing the vertical lifted-out state of a carrier vehicle, parked on a piece of ground, for a lifting device with a support system, a computer program product for executing such a method, a controller for a support system for carrying out such a method, and a vehicle with such a controller.

It is known in the state of the art that carrier vehicles are supported on a piece of ground with support systems, for example for increasing the stability of the carrier vehicle. The supporting is normally effected via supporting legs which are adjustable in terms of their longitudinal extent and which can be supported on the piece of ground and can influence the inclination and the lifted-out state of the carrier vehicle through a change in the longitudinal extent. An inclination of the carrier vehicle and/or of the lifting device relative to a predefined or predefinable spatial direction and/or spatial plane can be detected with an inclination sensor.

Devices in the form of hydraulically operable support systems for changing the vertical lifted-out state are known in the state of the art. To change the vertical lifted-out state in a controlled manner, systems used in lifting devices, such as for instance lifting platforms, have pressure compensators for controlling volume flows for hydraulic drives. When several of drives supporting legs are actuated at the same time, irrespective of different loads on the supporting legs, the same volume flow can thus be distributed to each drive. The supporting legs can thus be retracted and extended synchronously and uniformly.

A disadvantage of devices for changing the vertical lifted-out state using pressure compensators is the associated higher complexity of the hydraulic system. Additional pressure valves, devices for measuring pressures exerted on valves and proportional or control valves for controlling the volume flows increase the susceptibility to faults and the maintenance requirements of such hydraulic systems.

### SUMMARY OF THE INVENTION

The object of the invention is to specify a method for changing the vertical lifted-out state of a carrier vehicle for a lifting device that is improved compared with the state of the art.

The object is achieved by a method as described below, a computer program product for executing such a method, and a controller which is formed for carrying out such a method.

The method serves for changing the vertical lifted-out state of a carrier vehicle for a lifting device with a support system on a piece of ground. Through a support system, for example, an increase in the stability of the carrier vehicle can be achieved and the carrier vehicle can be raised relative to a piece of ground or lowered toward it. It is not to be ruled out that a carrier vehicle for a lifting device with a support system can be oriented relative to a predefined or predefinable spatial direction and/or spatial plane.

A predefined or predefinable spatial plane can be, for example, a horizontal plane.

A vertical lifted-out state of a carrier vehicle for a lifting device can be with reference to a vertical distance, in particular measured along a vertical, of a frame or of a reference point on the frame of the carrier vehicle from the surface of a piece of ground used for the supporting. A vertical lifted-out state, in particular measured along a vertical, can also be with reference to a lifting device arranged on a carrier vehicle, for instance a crane base or a crane column of a lifting device.

A detected inclination can be, for example, an angle of a substantially vertically running swivel axis of a crane column of a lifting device relative to a horizontal plane, spatial plane or spatial direction.

In a parked state, an orientation of the swivel axis of the crane column at an at least approximately right angle relative to the horizontal can be sought.

In particular, with reference to the horizontal, an inclination of between 0° and 3° with respect to the horizontal can be sought.

The supporting is normally effected via supporting legs which are adjustable in terms of their longitudinal extent and which can be supported on the piece of ground and can influence the vertical lifted-out state and the inclination of the carrier vehicle and/or the lifting device through a change in the longitudinal extent.

By a current inclination can be meant, in principle, an inclination of the carrier vehicle and/or the lifting device prevailing currently, thus at the moment a method step is carried out.

A current inclination of the carrier vehicle and/or the lifting device can exist due to parking on an inclined piece of ground. A current inclination can also be caused by a payload of the carrier vehicle or a loading of a lifting device arranged on the carrier vehicle.

The support system can be connected to the vehicle frame. If the carrier vehicle has a lifting device, the support system can be connected to the lifting device. The lifting device itself can also have supporting legs.

The support system can have two or more supporting legs. The supporting legs can be arranged in different positions relative to the carrier vehicle or the lifting device.

In particular, the support system can have four supporting legs, which can be part of a so-called H support (H-shaped arrangement of the supporting legs) or an X support (X-shaped arrangement, also called star support).

The support system can have a controller for actuating drives of the supporting legs using control commands. For example, the supporting legs can have drives in the form of hydraulic cylinders for retracting and/or extending the supporting legs, and the controller can actuate magnetically operable control valves of the hydraulic cylinders using control pulses. A corresponding actuation of electric drives is not to be ruled out.

The controller can have a user interface. A user interface of a controller can generally be designed as a control element of the controller, for instance as a lever, a button or an area on a touch-sensitive display, in particular on a mobile remote control of the controller of the lifting device. A user interface of a controller can generally be formed as an interface for the exchange of data.

Control commands for the drives can be generated by a user through provision of operating commands via a user interface of the controller. Such operating commands can also initiate a performance of the method.

In the method, control commands can be generated and output to the drives at least in a partially automated manner.

It is not to be ruled out that the support system has horizontally adjustable supporting arms, on which the supporting legs are arranged. It is also not to be ruled out that the controller is formed for actuating drives of the supporting arms using control commands.

The support system can have at least one inclination sensor for detecting an inclination of the carrier vehicle and/or of the lifting device relative to at least one predefined or predefinable spatial direction and/or spatial plane.

For example, the inclination of the carrier vehicle and/or of the lifting device relative to two spatial directions can be detected.

In particular, inclinations relative to two spatial directions which span a horizontal plane can be detected.

For example, an inclination about a transverse axis and/or about a longitudinal axis of a carrier vehicle, for example with reference to a frame of the carrier vehicle, can be detected. The detected inclination can be with reference, for example, to a horizontal orientation of the carrier vehicle.

For example, an inclination of a lifting device arranged on a carrier vehicle, in particular a crane column of a lifting device relative to at least one spatial direction in a horizontal and/or vertical plane, can be detected.

A detected inclination can be, for example, an angle of a substantially vertically running swivel axis of a crane column of a lifting device relative to a horizontal plane, spatial plane or spatial direction. For the orientation, an at least approximately right angle of the swivel axis of the crane column relative to the horizontal can be sought.

The support system can have at least one distance sensor for detecting a distance of the carrier vehicle and/or the lifting device relative to a piece of ground used for the supporting, whereby the vertical lifted-out state can be characterized. Distance sensors can be formed as distance measurement devices or devices for measuring the travel time of signals, such as optical, generally electromagnetic or acoustic distance meters.

The detected inclination and/or the detected distance can be supplied to the controller and included in calculations.

In the method, in at least one calculation method step a sequence of control commands for the sequential and time-limited actuation of individual drives of the supporting legs of the support system can be calculated.

The calculation of the control commands can be effected with the requirement that, with the support system, a changing of the vertical lifted-out state of the carrier vehicle is effected substantially while maintaining the current inclination of the carrier vehicle and/or of the lifting device, thus for example the inclination currently prevailing while a method step is carried out. The inclination of the carrier vehicle can vary within a predefinable or predefined range for an inclination deviation, but remains substantially the same when the vertical lifted-out state of the carrier vehicle is changed.

The calculation of the control commands can be effected such that a raising and/or lowering of the carrier vehicle and possibly of a lifting device arranged thereon is achievable to a certain degree through the execution of the control commands. The current inclination of the carrier vehicle and possibility of a lifting device arranged thereon only changes within a predefinable or predefined range for an inclination deviation during the raising and/or lowering.

By current inclination of the carrier vehicle and/or of the lifting device can be meant the inclination of the carrier vehicle and/or of the lifting device prevailing immediately before or while the calculation method step is carried out.

In at least one lift-out method step, in principle, an actuation of the drives of the supporting legs of the support system can be effected for changing the vertical lifted-out state of the carrier vehicle and/or of the lifting device. During execution of a lift-out method step the vertical lifted-out state of the carrier vehicle and/or of the lifting device can be at least partially reduced or increased.

During actuation of the drives of the supporting legs of the support system using the sequence of control commands a sequential and time-limited actuation of individual drives of the supporting legs of the support system can be effected using control pulses.

Individual drives of the supporting legs can be actuated substantially separately from each other in terms of time in an order or sequence.

The actuation of the drives can be effected using control pulses which are sequentially output by the controller and time-limited.

An activation of a drive of a supporting leg can, in principle, be effected for the time duration of a control pulse.

Through the method, instead of a clocked actuation, thus a temporally dimensioned, continuous and possibly simultaneous actuation, of the supporting legs, a change in the lifted-out state of a carrier vehicle, parked on a piece of ground, for a lifting device with a support system can be broken down into a sequential sequence of a plurality of control pulses with, in each case, limited time duration.

Through the actuation of the drives using control pulses which are sequentially output by the controller and time-limited, a vertical lifted-out state of the carrier vehicle and/or of the lifting device can be incrementally reduced or increased.

In a calculation method step, a calculation of the sequence of control commands can advantageously be effected on the basis of at least one parameter of the support system.

A detection of a current inclination as a parameter of the support system can be effected with at least one inclination sensor of the support system for detecting an inclination of the carrier vehicle and/or of the lifting device relative to at least one predefined or predefinable spatial direction and/or spatial plane. A current inclination, thus immediately before or while a method step is carried out, can thus be detected with at least one inclination sensor of the support system.

In a calculation method step, a calculation of the sequence of control commands can therefore be effected on the basis of a currently detected inclination of the carrier vehicle and/or of the lifting device. The sequence of control commands corresponding to the changing of the vertical lifted-out state can be calculated while maintaining the currently detected inclination of the carrier vehicle and/or of the lifting device relative to at least one predefined or predefinable spatial direction and/or spatial plane within a predefinable or predefined range for an inclination deviation.

Alternatively or in combination, at least one parameter of the drives of the supporting legs can be predefined or predefinable as a parameter of the support system. Predefinition of a parameter of the drives of the supporting legs can be effected via a user interface of the controller, for example by a user in operational use and/or by the manufacturer during the construction of the lifting device and/or of a carrier vehicle with a lifting device.

In a calculation method step, a calculation of the sequence of control commands can therefore be effected on the basis of the parameters of the drives of the supporting legs. A metrological detection of the current inclination may not be strictly necessary.

Predefinition of at least one parameter of the support system can advantageously make it possible to calculate the sequence of control commands which, when executed in a lift-out method step, brings about a substantially identical change in the longitudinal extent of all actuated drives of the supporting legs. Maintenance of the current inclination within a predefinable or predefined range for an inclination deviation can thus be achieved.

A change in the longitudinal extent of all actuated drives of the supporting legs can be within a predefined or predefinable tolerance range. The tolerance range for the change in the longitudinal extent can correspond to a predefined or predefinable range for an associated inclination deviation.

A change in the longitudinal extent of an individual supporting leg through actuation of a dedicated drive using a correspondingly calculated control pulse can result in an inclination deviation within a predefined or predefinable range for an associated inclination deviation.

A change in the longitudinal extent of an individual supporting leg through actuation of a dedicated drive using a correspondingly calculated control pulse can be in a range of from 1 mm to 150 mm, preferably in a range of from 1 mm to 50 mm.

Overall, a change in the longitudinal extent using the sequence of control commands can be in a range from 1 cm to 100 cm. Larger changes in the longitudinal extents are not to be ruled out.

Parameters of the support system, which can be suppliable to the controller and can be included in a calculation of the sequence of control commands, can generally include:
parameters of the drives of the supporting legs, such as for instance lifting rates, piston diameters, piston areas, pumping power, possibly taking into account return-oil recycling, and/or electrical power, and/or
parameters of the geometry of the supporting legs, such as for instance the prevailing or possible longitudinal extent, or a length of extension arms with supporting legs of the support system, and/or
parameters of the position of the supporting legs, and/or
the number of supporting legs, and/or
an inclination of the carrier vehicle and/or of the lifting device currently detected with at least one inclination sensor of the support system, and/or
a predefinable or predefined range for an inclination deviation, and/or
a currently predefined pulse duration of a control pulse, for example calculated in a preceding calculation method step, and/or
a number and/or position of axles of the carrier vehicle, and/or
a position of a lifting device arranged on the carrier vehicle, and/or
a torsional and bending stiffness and/or a twisting of the carrier vehicle, and/or
a predefined or predefinable spatial direction and/or spatial plane, and/or
a position, in particular a nominal position, of the center of gravity of the carrier vehicle and/or of the lifting device, and/or
a load acting on a supporting leg, preferably by detection of a hydraulic pressure in a drive of a supporting leg and/or by a load sensor, and/or
parameters of the actuation of the drives of the supporting legs, such as for instance a control behavior of hydraulic valves of the hydraulic supply system of hydraulic drives and/or a switching behavior of energy s supply systems of electrical drives, and/or
a vertical distance, detected by at least one distance sensor of the support system, of the carrier vehicle and/or the lifting device relative to a piece of ground used for the supporting.

In an embodiment of the method, in an individual calculation method step a sequence of control commands can be calculated, which are implemented in a single pass through a subsequent lift-out method step.

In a further embodiment of the method, in a calculation method step, a sequence of control commands for the sequential and time-limited actuation of individual drives of the supporting legs of the support system for changing the vertical lifted-out state can generally be calculated. This can be a part of the total desired or required change for orienting the carrier vehicle and/or the lifting device. A repetition of a calculation method step and of a lift-out method step for achieving a total desired or predefined change is possible in such an embodiment of the method.

A repetition of a calculation method step and of the lift-out method step can be effected in a loop to further change the vertical lifted-out state of the carrier vehicle and/or of the lifting device. During each repetition of the loop a sequence of control commands for changing the vertical lifted-out state while maintaining a current inclination within a predefinable or predefined range for an inclination deviation can be calculated and the sequence of control commands can be implemented through actuation of the drives.

An actuation of the drives of the supporting legs of the support system can generally be effected until the vertical lifted-out state of the carrier vehicle and/or of the lifting device reaches or falls below a predefined or predefinable target value.

A predefined or predefinable target value can be with reference, for example, to a vertical distance, in particular measured along a vertical, of a frame or of a reference point on the frame of the carrier vehicle or of the lifting device from the surface, and/or can be with reference to a change in the longitudinal extent of the supporting legs and can be detected via a corresponding sensor. Predefinition can be effected by a user via a corresponding user interface of a controller.

An actuation of the drives of the supporting legs of the support system can be effected so long as an operating command for changing the vertical lifted-out state, thus in other words an operating command for carrying out the method, is provided by a user via a user interface of a controller.

For the vertical lifted-out state of the carrier vehicle and/or of the lifting device can be effected in each pass through a loop, during which a repetition of the calculation method step and of the lift-out method step is effected, a partial reduction or increase of the vertical lifted-out state.

In each pass through the loop, during detection of the supporting by an inclination sensor, an inclination of the carrier vehicle and/or of the lifting device and a corresponding deviation from a currently detected inclination to be maintained can be detected. A deviation from an inclination detected in a preceding loop pass, for example the current inclination detected during a first pass, can be taken as a reference. A currently detected inclination within a range for an inclination deviation can thus be maintained for several loop passes.

In an advantageous embodiment of the method, in a calculation method step, a sequence of control commands for changing the vertical lifted-out state of the carrier vehicle and/or of the lifting device can be calculated for all drives of the supporting legs of the support system involved in the supporting. In a lift-out method step following that calculation method step, at least one corresponding actuation of all drives of the supporting legs of the support system involved in the supporting can be effected using the sequence of control commands for changing the vertical lifted-out state of the carrier vehicle and/or of the lifting device. A changing of the lifted-out state with a minimal change in the currently detected inclination can thereby be achievable. One of the supporting legs involved in the supporting can also be prevented from lifting off the piece of ground.

Within a sequence, drives of individual supporting legs can be actuated several times.

A detection of an inclination of the carrier vehicle and/or of the lifting device relative to the horizontal is advantageously effected with an inclination sensor of the support system. A lift-out method step can advantageously be carried out only if the inclination of the carrier vehicle and/or of the lifting device currently detected in a calculation method step is in a range of from 0° to 10°, preferably within 0° to 5°, particularly preferably within 0° to 3°, with respect to the horizontal. A range of from 0° to 1° is also conceivable.

In an inclination close to the horizontal, as described above, the carrier vehicle and/or the lifting device is normally referred to as leveled. In other words, a lift-out method step can advantageously be carried out only if the carrier vehicle and/or the lifting device are substantially leveled.

In particular, the method can advantageously be carried out only if the carrier vehicle and/or the lifting device are substantially in a horizontal orientation.

An inclination suitable for carrying out a lift-out method step can be effected, for example, by parking on a substantially horizontal piece of ground or by leveling the carrier vehicle and/or the lifting device.

It is not to be ruled out that the carrier vehicle and/or the lifting device is and/or has been brought into an inclination suitable for carrying out a lift-out method step by a method for supporting a carrier vehicle parked on a piece of ground. In a suitable leveling calculation method step, a sequence of control commands for the sequential and time-limited actuation of individual drives of the supporting legs of the support system can be calculated on the basis of a currently detected inclination of the carrier vehicle and/or of the lifting device. In a leveling method step, an actuation of the drives of the supporting legs of the support system can be effected using the sequence of control commands for reducing the inclination of the carrier vehicle and/or of the lifting device relative to at least one predefined or predefinable spatial direction and/or spatial plane. Using the sequence of control commands, a sequential and time-limited actuation of individual drives of the supporting legs of the support system can be effected using control pulses.

In an advantageous embodiment of the method, for example after the carrier vehicle has been parked on the piece of ground, an actuation of the drives of the supporting legs of the support system can be effected in a floor-contact method step using control commands, through which the supporting legs are brought into contact with the piece of ground. The control commands can be calculated as a sequence of control commands for the sequential and time-limited actuation of individual drives of the supporting legs of the support system on the basis of a currently detected inclination of the carrier vehicle and/or of the lifting device.

The predefinable or predefined range for an inclination deviation can be within 0° to 10°, preferably within 0° to 5°, particularly preferably within 0° to 3°, with respect to the horizontal.

In a loop in a calculation method step, which follows a lift-out method step carried out beforehand, a detection of the change in the inclination due to the preceding lift-out method step can be effected with at least one inclination sensor of the support system. It can be determined whether a corresponding change in the inclination during the lifting-out of the carrier vehicle and/or of the lifting device was brought about when execution of the control commands was effected. It can be deduced from this whether the actuated supporting legs have been in floor contact. Loss of floor contact of one or more supporting legs can represent a termination condition for carrying out the method. It is not to be ruled out that a torsional and bending stiffness and/or a twisting of the carrier vehicle can be determined by the detection of the change in the inclination.

In an advantageous embodiment of the method, the time-limited actuation of the individual drives of the supporting legs of the support system using the sequence of control commands can be effected using control pulses with variable pulse duration. Different parameters of the support system can be taken into account with a variable pulse duration.

A variable pulse duration can advantageously make it possible to calculate the sequence of control commands which, when executed in a lift-out method step, brings about a substantially identical change in the longitudinal extent of all actuated supporting legs, possibly within a tolerance range.

A change in the longitudinal extent of an individual supporting leg through actuation of a dedicated drive using a control pulse with correspondingly calculated pulse duration can result in an inclination deviation within a predefined or predefinable range for an associated inclination deviation.

A scaling of the pulse durations of the control pulses can advantageously be effected, wherein, starting from a pulse duration of a selected control pulse, the durations of the control pulses from the sequence can be scalable to a desired maximum or minimum pulse duration.

The pulse duration of the control pulses can advantageously be 0.05 seconds to 3.50 seconds. The pulse duration of the control pulses can preferably be 0.25 seconds to 1.5 seconds. It is conceivable that the pulse duration of the control pulses is 0.25 to 0.50 seconds.

A variation of the pulse duration—and possibly of a duration of an overlap of successive control pulses—can, in principle, be effected depending on:
parameters of the drives of the supporting legs, such as for instance the lifting rate, the piston diameter or the pumping power, possibly taking into account a return-oil recycling, and/or
parameters of the geometry of the supporting legs, such as for instance the prevailing or possible longitudinal extent, or a length of extension arms with supporting legs of the support system, and/or
parameters of the position of the supporting legs, and/or
the number of supporting legs, and/or
the currently measured inclination of the carrier vehicle and/or of the lifting device, and/or
the predefinable or predefined range for an inclination deviation, and/or
the currently predefined pulse duration, example for calculated in a preceding calculation method step, and/or
the number and/or position of axles of the carrier vehicle, and/or
the position of a lifting device arranged on the carrier vehicle, and/or
a torsional and bending stiffness and/or a twisting of the carrier vehicle, and/or
the predefined or predefinable spatial direction and/or spatial plane, and/or
a position of the center of gravity of the carrier vehicle and/or of the lifting device, and/or
a load acting on a supporting leg and detected by detection of a hydraulic pressure in a drive of a supporting leg and/or a load acting on a supporting leg and detected by a load sensor, and/or
parameters of the actuation of the drives of the supporting legs, such as for instance a control behavior of hydraulic valves of the hydraulic supply system of hydraulic drives or a switching behavior of energy supply systems of electrical drives, and/or
a vertical distance, detected by at least one distance sensor of the support system, of the carrier vehicle and/or the lifting device relative to a piece of ground used for the supporting.

In an advantageous embodiment of the method, the actuation of the drives of the individual supporting legs of the support system using the sequence of control commands can be effected in an actuation sequence in a predefinable or predefined order. Particular supporting legs of the support system can preferably be actuated.

A preferred actuation can be effected, for example, in order to keep deviations from the inclination to be maintained small or in order to take torsional and bending stiffnesses of the carrier vehicle into account.

A preferred actuation can comprise a selection or weighting of individual or several supporting legs.

In an advantageous embodiment of the method, the longitudinal extent of the supporting legs can be made larger and/or smaller when the drives of the supporting legs of the support system are actuated in a lift-out method step. The support system can thereby not only lift the carrier vehicle out away from the piece of ground, but also lower it toward the piece of ground.

In an advantageous embodiment of the method, the actuation of the individual drives of the supporting legs of the support system using the sequence of control commands can be effected using control pulses with a time-limited, predefined or predefinable overlap between successive control pulses. Control pulses succeeding one another in the sequence of control commands can be simultaneously output by the controller in sections.

An overlap of control pulses can be calculated in a calculation method step.

Thus, for example, the activation of a drive of one supporting leg for the duration of a control pulse can be started by output by the controller, and the activation of the drive of the next supporting leg according to the calculated sequence can already be started before the ongoing control pulse has ended.

The time-limited, predefined or predefinable duration of the overlap determines the duration of an activation, which is simultaneous in sections, of drives of supporting legs.

A substantially smooth orientation of a carrier vehicle can be effected through an overlap between successive control pulses. Vibrations occurring due to abrupt switching on and off of drives of supporting legs can be lessened.

Within the overlap between successive control pulses a simultaneous actuation of at most two drives can advantageously be effected.

The duration of the overlap between successive control pulses output by the controller can generally be between 0.01 seconds and 0.5 seconds. The duration of the overlap can preferably be between 0.01 seconds and 0.1 seconds.

In an advantageous embodiment of the method, after changing of the vertical lifted-out state of the carrier vehicle and/or of the lifting device, thus for instance after one or more passes through the calculation method step and the lift-out method step, a continuous detection of an inclination of the carrier vehicle and/or of the lifting device relative to at least one predefined or predefinable spatial direction and/or spatial plane can be effected in a monitoring method step.

If, for example, after supporting and lifting-out of the carrier vehicle, a lifting device arranged thereon is used during working operation, or for example a payload of the carrier vehicle is altered, undesired changes in the inclination of the carrier vehicle and/or of the lifting device can occur due to the loads and/or changes occurring in the piece of ground used for the supporting. These can be recognized and determined through a continuous detection of the inclination.

When the detected inclination reaches or exceeds a predefined or predefinable deviation, but also independently of the value of a detected inclination, to minimize the inclination of the carrier vehicle and/or of the lifting device an execution of at least one leveling calculation method step a sequence of control commands for the sequential and time-limited actuation of individual drives of the supporting legs of the support system can be calculated on the basis of a currently detected inclination of the carrier vehicle and/or of the lifting device, and in a leveling method step an actuation of the drives of the supporting legs of the support system can be effected using the sequence of control commands for reducing the inclination of the carrier vehicle and/or of the lifting device relative to at least one predefined or predefinable spatial direction and/or spatial plane. Using the sequence of control commands, a sequential and time-limited actuation of individual drives of the supporting legs of the support system can be effected using control pulses. An inclination can thus for instance again be brought into the predefinable or predefined range for an inclination deviation within 0° to 10°, preferably within 0° to 5°, particularly preferably within 0° to 3°, with respect to the horizontal.

During the minimization of the inclination, the currently prevailing lifted-out state can be substantially maintained, possibly within a predefined or predefinable tolerance range for the lifted-out state.

A minimization of the inclination can be effected autonomously by the controller or after corresponding confirmation, or by targeted selection by a user.

Protection is also sought for a computer program product comprising commands which, when executed by a computing unit, prompt the latter to execute a method as described previously from a storage unit which is in or can be brought into data connection with the computing unit.

Commands of the computer program product can be stored, for example, in at least one storage unit of a controller and can be executed by at least one computing unit of a controller.

Protection is also sought for a controller for a support system which is formed for carrying out a method as described previously.

The controller can, in principle, have at least one computing unit and at least one storage unit. The computing unit can be in or be able to be brought into data connection with the storage unit.

In a calculation operating mode, a sequence of control commands for the sequential and time-limited actuation of individual drives of the supporting legs of the support system can be calculable by the controller for changing the vertical lifted-out state while maintaining the current inclination within a predefinable or predefined range for an inclination deviation.

The calculation can be effected, for example, by a computing unit of the controller, and calculated control commands can be stored in a storage unit of the controller.

In an actuation operating mode of the controller, the drives of the supporting legs of the support system can be actuatable using the sequence of control commands for changing the vertical lifted-out state of the carrier vehicle and/or of the lifting device relative to the piece of ground. Using the sequence of control commands, a sequential and time-limited actuation of the drives of the supporting legs of the support system can be effected using control pulses.

Control commands stored in a storage unit of the controller can be output by the controller in accordance with the sequence.

The control commands can be output by the controller, for example, to controllable valves of a hydraulic system of a lifting device, wherein the controllable valves can control a supply to hydraulic drives of the support system.

The controller can have a user interface for a user, which can generally be designed as a control element of the controller, for instance as a lever, a button or an area on a touch-sensitive display, in particular on a mobile remote control of the controller of the lifting device, and can generally be suitable for the exchange of data with the controller. The controller can be arranged at least partially on the lifting device or can be arrangeable thereon.

Protection is also sought for a vehicle, in particular a carrier vehicle with a lifting device, with a support system as described previously and a controller as described previously for the support system. The lifting device can generally be formed as a crane, in particular as an articulated arm crane.

### BRIEF DESCRIPTION OF THE DRAWINGS

Embodiments of the invention will be discussed below with reference to the drawings, in which:

FIG. 1, shows, schematically, the procedure of an embodiment of the method,

FIG. 2, shows, schematically, the procedure of a further embodiment of the method,

FIG. 3 is a side view of an embodiment of a carrier vehicle parked on an inclined piece of ground,

FIGS. 4a and 4b are side views of an embodiment of a carrier vehicle parked on an inclined piece of ground, leveled and lifted out,

FIG. 5 is a top view of an embodiment of a carrier vehicle,

FIG. 6 is a schematic representation of a top view of an embodiment of a carrier vehicle

FIG. 7 is a schematic representation of a lifting device with an embodiment of a support system

FIG. 8 is a perspective view of an embodiment of a carrier vehicle,

FIGS. 9a to 9d is a schematic representation of a changing of the vertical lifted-out state, and

FIGS. 10a and 10b, in each case, is a schematic representation of three successive control pulses.

### DETAILED DESCRIPTION OF THE INVENTION

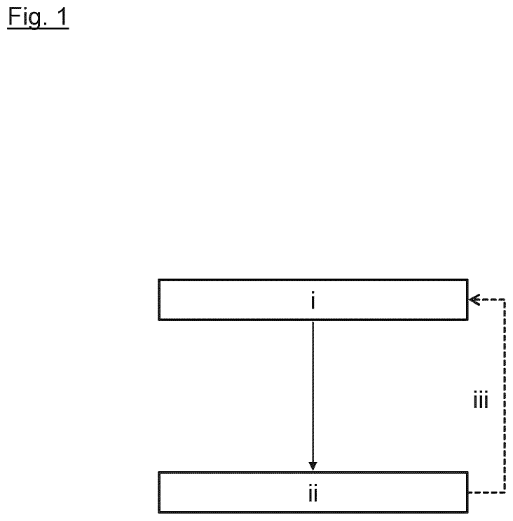

With reference to the embodiments, shown in the figures listed above, of a carrier vehicle 8 with a support system 7, FIG. 1 illustrates an embodiment of a method for changing the vertical lifted-out state of a carrier vehicle 8, parked on a piece of ground 10, for a lifting device 9 with a support system 7. The support system 7 comprises, as represented,
supporting legs 1, 2, 3, 4, vertically adjustable in terms of their longitudinal extent, for supporting on the piece of ground 10, and
a controller 5 for actuating drives of the supporting legs 1, 2, 3, 4 using control commands, and
advantageously at least one inclination sensor 6 for detecting an inclination α of the carrier vehicle 8 and/or of the lifting device 9 relative to at least one predefined or predefinable spatial direction and/or spatial plane.

In at least one calculation method step i a sequence of control commands for the sequential and time-limited actuation of individual drives of the supporting legs 1, 2, 3, 4 of the support system 7 can be calculated for changing the vertical lifted-out state while maintaining the current inclination α within a predefinable or predefined range Δα for an inclination deviation.

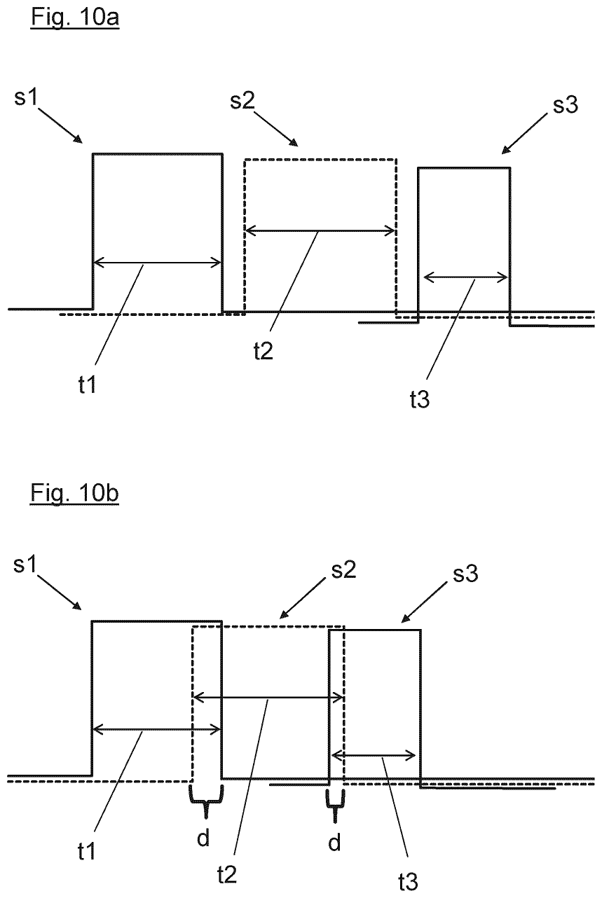

In at least one lift-out method step ii following that an actuation of the drives of the supporting legs 1, 2, 3, 4 of the support system 7 can be effected using the sequence of control commands for changing the vertical lifted-out state of the carrier vehicle 8 and/or of the lifting device 9 relative to the piece of ground 10, wherein, using the sequence of control commands, a sequential and time-limited actuation of individual drives of the supporting legs 1, 2, 3, 4 of the support system 7 can be effected using control pulses s1, s2, s3 (see FIGS. 10a and 10b).

In a calculation method step i a calculation of the sequence of control commands can be effected on the basis of at least one parameter of the support system 7, wherein a current inclination α is detectable as a parameter of the support system 7 with at least one inclination sensor 6 of the support system 7, and in a calculation method step i a calculation of the sequence of control commands is effected on the basis of a currently detected inclination α of the carrier vehicle 8 and/or of the lifting device 9.

Alternatively or in combination, at least one parameter of the drives of the supporting legs 1, 2, 3, 4 can be predefined or predefinable as a parameter of the support system 7, for instance using a user interface 21, and in a calculation method step i a calculation of the sequence of control commands is effected on the basis of the parameters of the drives of the supporting legs 1, 2, 3, 4.

Parameters of the support system 7, which can be suppliable to the controller 6 and can be included in a calculation of the sequence of control commands, can generally include:
parameters of the drives of the supporting legs 1, 2, 3, 4, such as for instance lifting rates, piston diameters, piston areas, pumping power and/or electrical power and/or
parameters of the geometry of the supporting legs 1, 2, 3, 4, such as for instance the prevailing or possible longitudinal extent x11, x12, x13, x21, x22, or a length of extension arms with supporting legs 1, 2, 3, 4 of the support system 7 and/or
parameters of the position of the supporting legs 1, 2, 3, 4 and/or
the number of supporting legs 1, 2, 3, 4 and/or
an inclination α of the carrier vehicle 8 and/or of the lifting device 9 currently detected with at least one inclination sensor 6 of the support system 7, and/or
a predefinable or predefined range Δα for an inclination deviation and/or
a currently predefined pulse duration t1, t2, t3 of a control pulse s1, s2, s3, for example calculated in a preceding calculation method step i, and/or
a number and/or position of axles of the carrier vehicle 8 and/or
a position of a lifting device 9 arranged on the carrier vehicle 8 and/or
a torsional and bending stiffness and/or a twisting of the carrier vehicle 8 and/or
a predefined or predefinable spatial direction H and/or spatial plane and/or
a position, in particular a nominal position, of the center of gravity of the carrier vehicle 8 and/or of the lifting device 9 and/or
a load acting on a supporting leg 1, 2, 3, 4, preferably by detection of a hydraulic pressure in a drive of a supporting leg 1, 2, 3, 4 and/or by a load sensor and/or
parameters of the actuation of the drives of the supporting legs 1, 2, 3, 4, such as for instance a control behavior of hydraulic valves of the hydraulic supply system of hydraulic drives or a switching behavior of energy supply systems of electrical drives and/or
a vertical distance, detected by at least one distance sensor of the support system 7, of the carrier vehicle 8 and/or the lifting device 9 relative to a piece of ground 10 used for the supporting.

An actuation of the drives of the supporting legs 1, 2, 3, 4 of the support system 7 can be effected, for example in an optional loop iii with a repetition of the calculation method step i and of the lift-out method step ii, until the vertical lifted-out state of the carrier vehicle 8 and/or of the lifting device 9 reaches or falls below a predefined or predefinable target value, or so long as an operating command for changing the vertical lifted-out state is provided by a user via a user interface of a controller 5.

Generally, in the loop iii, in a calculation method step i, which can follow a leveling method step ii carried out beforehand, a detection of the change in the inclination α due to the preceding leveling method step ii can be effected. Effects of the actuation carried out can thereby be assessed.

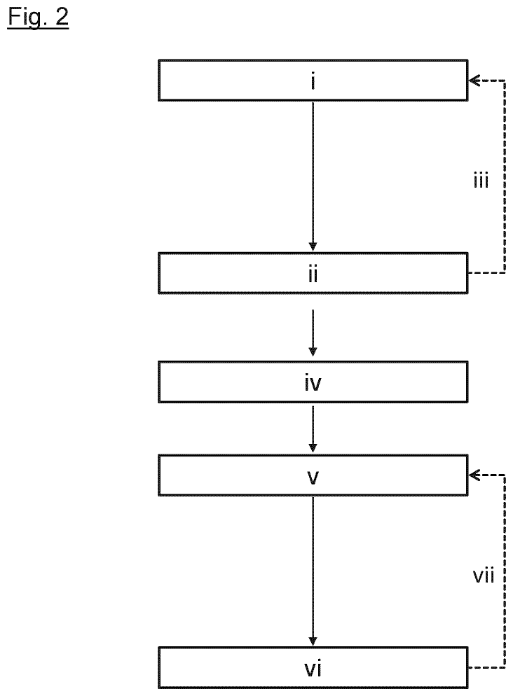

As in a particularly preferred embodiment of the method, as is shown schematically in FIG. 2, after changing of the vertical lifted-out state of the carrier vehicle 8 and/or of the lifting device 9 (steps i and ii and optionally iii) has been effected, a continuous detection of an inclination α of the carrier vehicle 8 and/or of the lifting device 9 relative to at least one predefined or predefinable spatial direction and/or spatial plane can be effected in a monitoring method step iv.

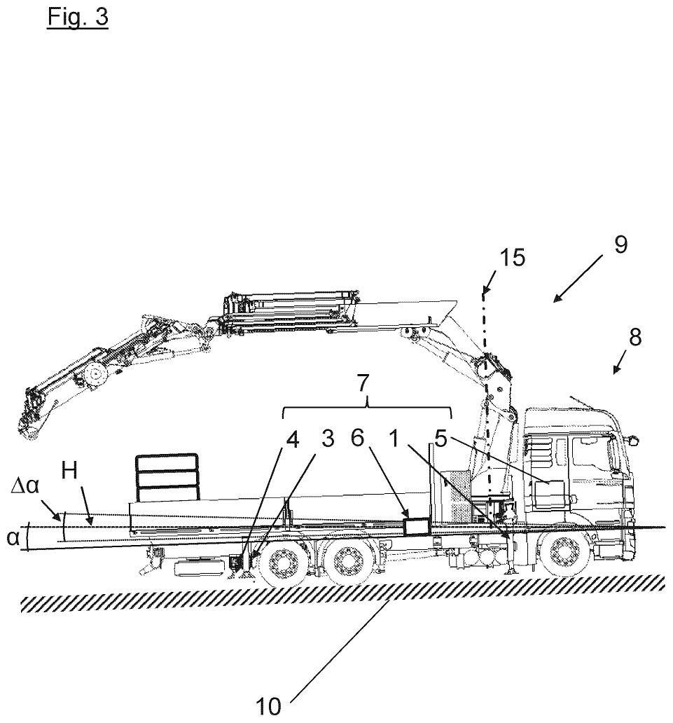

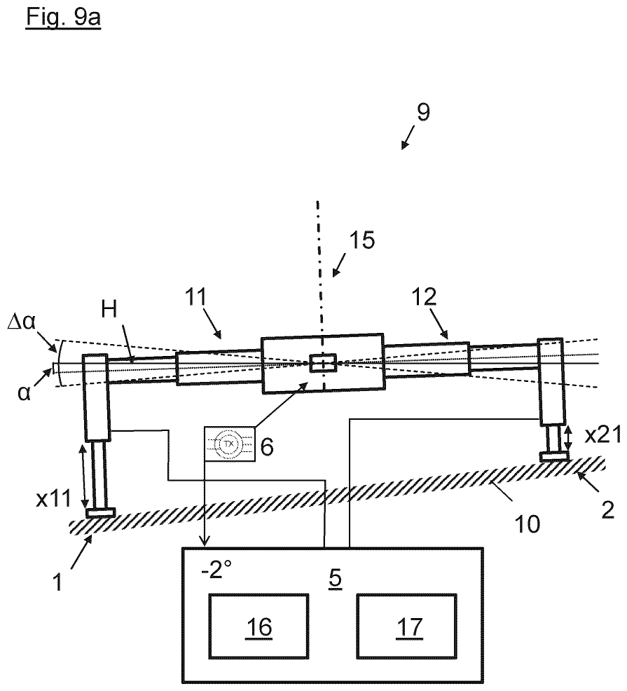

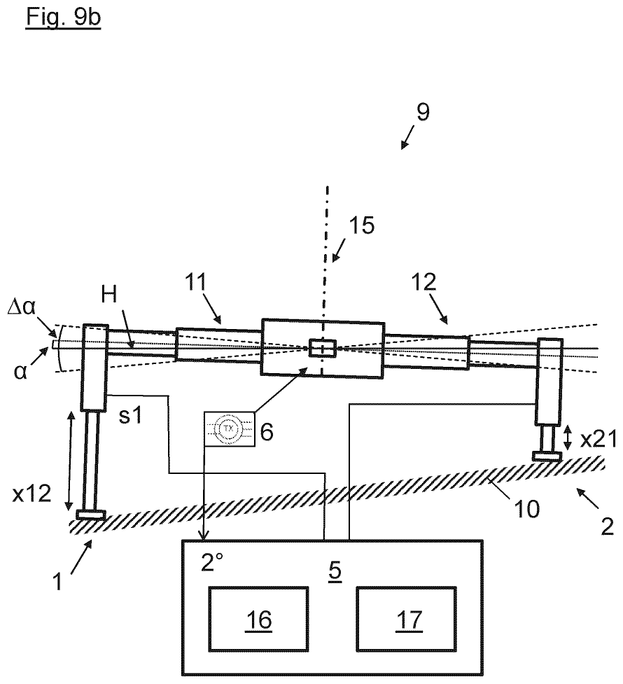

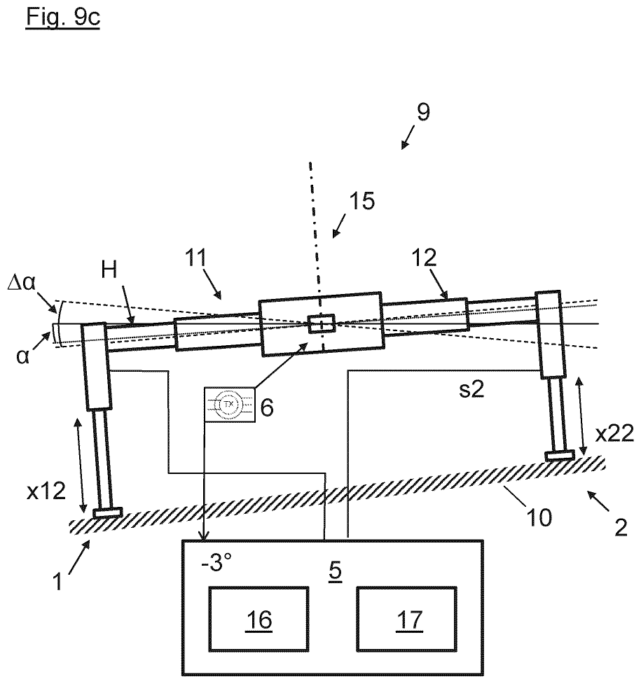

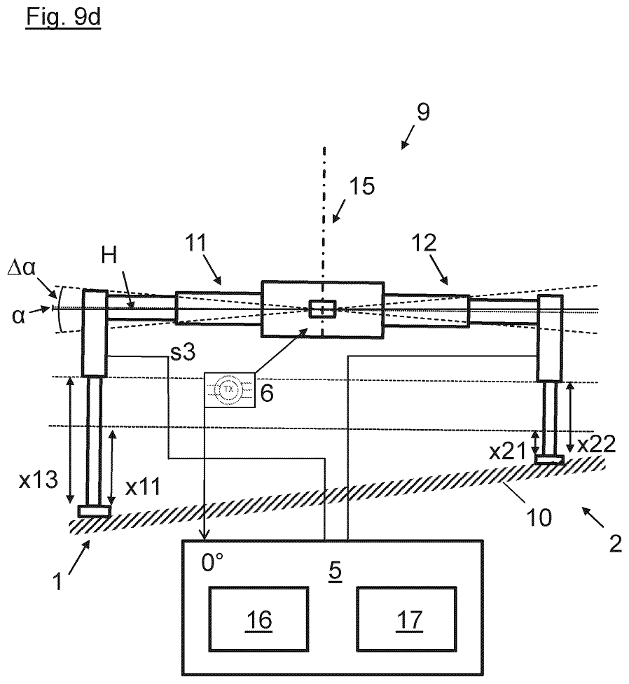

When the detected inclination α reaches or exceeds a predefined or predefinable range Δα for an inclination deviation (see for instance FIG. 3 and FIG. 9a), a repetition of the embodiment of at least one calculation method step i and at least one lift-out method step ii can be effected.

To maintain the inclination α of the carrier vehicle 8 and/or of the lifting device 9 within the predefined or predefinable range Δα for an inclination deviation, a leveling calculation method step v and a leveling method step vi can be effected in an optional loop vii until the detected inclination α of the carrier vehicle 8 and/or of the lifting device 9 is again within the predefined or predefinable range Δα for an inclination deviation.

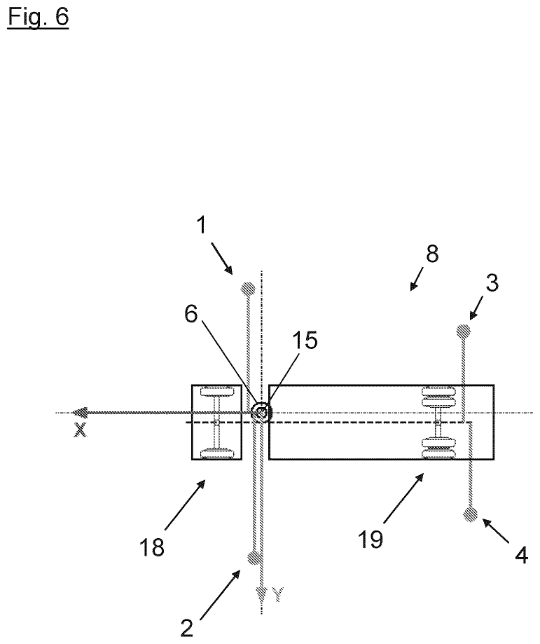

FIG. 3 shows a side view of an embodiment of a carrier vehicle 8 parked on an inclined piece of ground 10 (inclination angle in the representation is approximately 5°) with a lifting device 9 arranged thereon in the form of an articulated arm crane. The piece of ground 10 is inclined by an angle with respect to the horizontal H. In this unsupported state the carrier vehicle 8 parked on the inclined piece of ground 10 is inclined with respect to the horizontal H substantially about a transverse axis y of the carrier vehicle 8 (see FIG. 6) by the inclination α, in this embodiment measured relative to the vehicle frame. An inclination of the carrier vehicle 8 about a longitudinal axis x can analogously exist, but is not shown in this example embodiment.

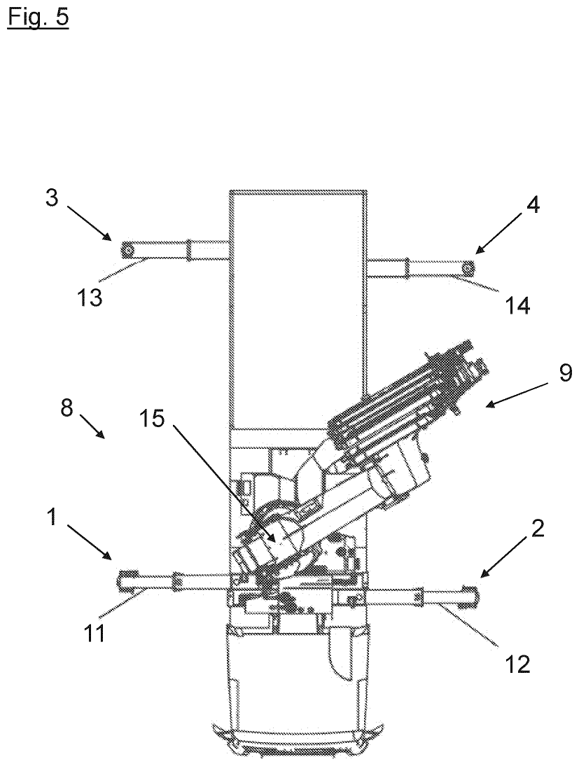

In this embodiment, the carrier vehicle 8 has a support system with four supporting legs 1, 2, 3, 4 (partially concealed, cf. also FIG. 5), an inclination sensor 6 and a controller 5, arranged on the carrier vehicle 8 in this embodiment, for actuating drives of the supporting legs 1, 2, 3, 4 using control commands.

For safety reasons, it can for instance be the case that the given current inclination α is not suitable for allowing a lift-out method step ii to be carried out, meaning that a leveling of the vehicle may be necessary. It can for example be predefined that the currently detected inclination α of the carrier vehicle 8 and/or of the lifting device 9 is in a range of from 0° to 3° with respect to the horizontal H. Such an example range Δα for an inclination deviation of the current inclination α is drawn in on both sides of the horizontal H in FIG. 3. In the case of parking on a correspondingly uninclined piece of ground 10, a leveling before the method is carried out can be omitted.

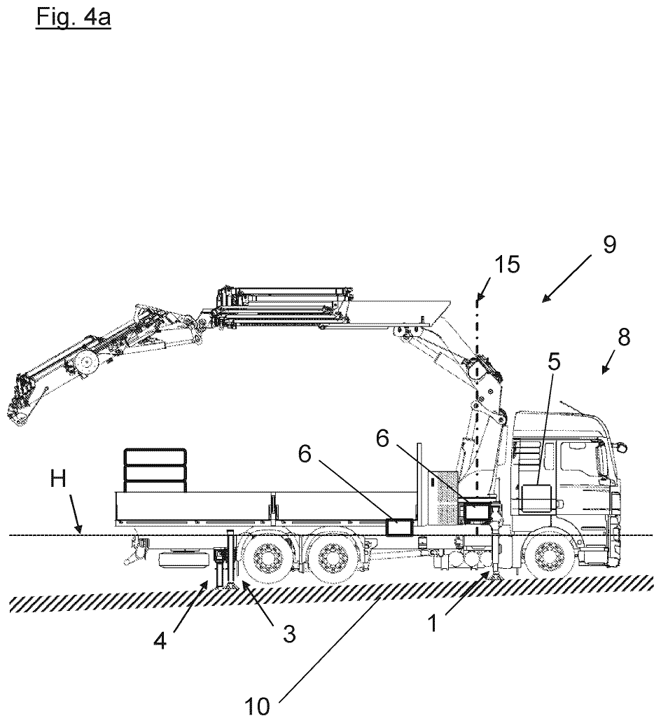

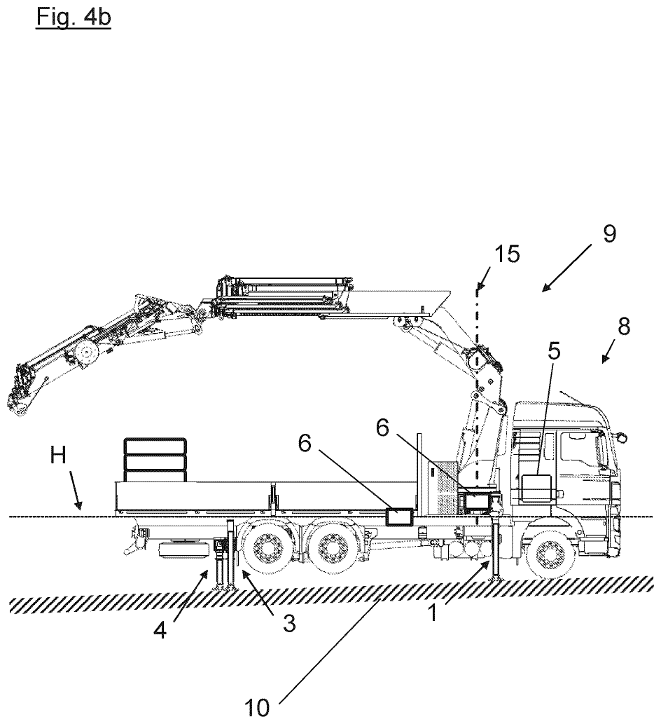

FIG. 4a shows a side view of the embodiment shown in FIG. 3 of a carrier vehicle 8 parked on an inclined piece of ground 10. The parked carrier vehicle has been oriented relative to the horizontal H and thus leveled after supporting has been effected via the supporting legs 1, 2, 3, 4 on the piece of ground 10. The inclination α with respect to the horizontal H is substantially 0° in the representation.

Such a current inclination α with respect to the horizontal H can be suitable for carrying out a lift-out method step ii of the method.

Unlike what is represented, the inclination can also be with reference to the angle of a substantially vertically running swivel axis 15 of a crane column of the lifting device 9 relative to the horizontal H or to a vertical plane. For this, FIG. 4a shows an alternative or additional arrangement of the inclination sensor 6. For the orientation, an at least approximately right angle of the swivel axis 15 of the crane column relative to the horizontal H can be sought.

Generally, an orientation relative to a predefined or predefinable spatial direction and/or spatial plane can be possible.

FIG. 4b shows a side view of the carrier vehicle 8, shown in FIG. 4a, parked on an inclined piece of ground 10, wherein the carrier vehicle 8 has been raised by a method for changing the vertical lifted-out state relative to the piece of ground 10 while maintaining the current inclination c.

It can be seen that at least one wheel of the carrier vehicle 8 has remained on the piece of ground 10, thus the carrier vehicle 8 has not been completely lifted out by the supporting legs 1, 2, 3, 4. Unlike what is represented, a complete lifting-out of the carrier vehicle 8 can also be effected.

FIG. 5 shows a top view of an embodiment as shown previously of a carrier vehicle 8. As represented, the support system 7 has horizontally adjustable supporting arms 11, 12, 13, 14, on which the supporting legs 1, 2, 3, 4 are arranged. The controller 5 can be formed for actuating drives of the supporting arms 11, 12, 13, 14 using control commands.

FIG. 6, which shows a schematic representation of a top view of an embodiment of a carrier vehicle 8 with a front axle 18 and a rear axle 19 analogous to the preceding embodiments, illustrates the longitudinal axis x and the transverse axis y of the carrier vehicle 8. The inclination sensor 6 can, as represented, lie at the origin of the coordinate system spanned by the longitudinal axis x and the transverse axis y and situated on the swivel axis 15 of the crane column of the lifting device 9.

An orientation about the longitudinal axis x can be effected through the relationship of the longitudinal extents of the supporting legs 1 and 2 (cf. FIG. 9). An orientation about the transverse axis y can be effected through the constant component, thus the respective absolute value of the longitudinal extents.

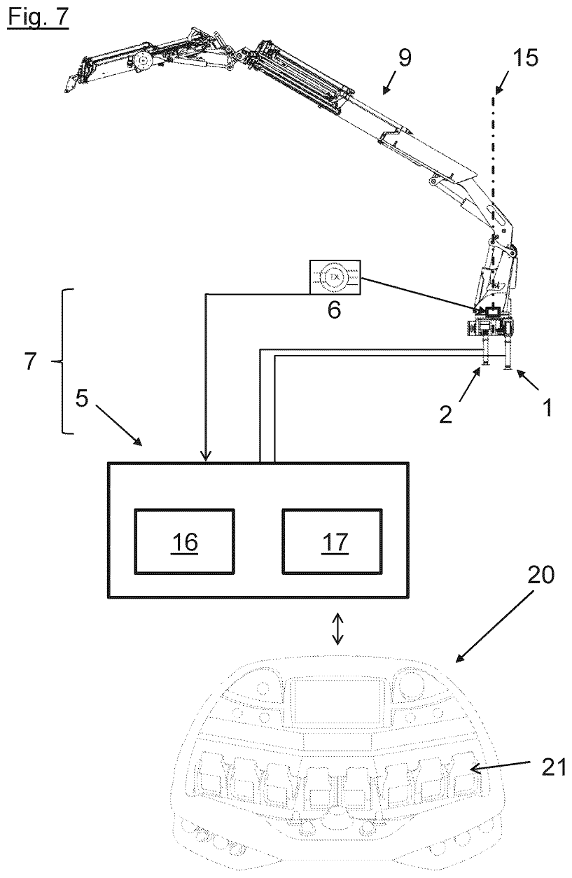

A variation of the pulse duration t1, t2, t3 of the control pulses s1, s2, s3, using which the controller 5 (cf. FIG. 7) can actuate the drives of the supporting legs 1, 2, 3, 4, and possibly a variation of an overlap d, can be effected depending on:
parameters of the drives of the supporting legs 1, 2, 3, 4 and/or
parameters of the geometry of the supporting legs 1, 2, 3, 4, for instance the distance thereof from the swivel axis 15 of the crane column of the lifting device 8 and/or
parameters of the position of the supporting legs 1, 2, 3, 4, for instance the arrangement thereof on the vehicle frame relative to a lifting device 8, in particular relative to a swivel axis 15 of a crane column of the lifting device 8, and/or
the number of supporting legs 1, 2, 3, 4 and/or
the currently measured inclination α of the carrier vehicle 8 and/or of the lifting device 9 and/or
the predefinable or predefined range Δα for an inclination deviation and/or
the currently predefined pulse duration t1, t2, t3 and/or
the position of axles 18, 19 of the carrier vehicle 8 and/or
the position of a lifting device 9 arranged on the carrier vehicle 8 and/or
a torsional and bending stiffness and/or a twisting of the carrier vehicle 8 and/or
the predefined or predefinable spatial direction and/or spatial plane.

FIG. 7 shows a schematic representation of a lifting device 9 with an embodiment of a support system 7. The support system 7 comprises, as represented,
two supporting legs 1, 2, vertically adjustable in terms of their longitudinal extent, for supporting on a piece of ground 10, and
a controller 5 for actuating drives of the supporting legs 1, 2 using control commands, and
at least one inclination sensor 6 for detecting an inclination α of the lifting device 9 relative to at least one predefined or predefinable spatial direction and/or spatial plane.

Unlike what is represented, the support system 7 can have additional supporting legs and several inclination sensors 6, for instance such as those in FIGS. 3 to 6.

Besides the inclination sensor 6, the controller 5 can generally also be able to be supplied with measured values relating to operating parameters of the supporting legs 1, 2.

The controller 5 can, in principle, have at least one computing unit 16 and at least one storage unit 17. The computing unit 16 can be in or be able to be brought into data connection with the storage unit 17.

The controller 5 can have a user interface 21 for a user, which can generally be designed as a control element of the controller, for instance as a lever, a button or an area on a touch-sensitive display, in particular, as represented in FIG. 7, on a mobile remote control 20 of the controller 5 of the lifting device 9.

The controller 5 can be arranged at least partially on the lifting device 9 or can be arrangeable thereon.

In a calculation operating mode a sequence of control commands in the form of control pulses s1, s2, s3 for the sequential and time-limited actuation of individual drives of the supporting legs 1, 2 of the support system 7 can be calculable by the controller 5 on the basis of a currently detected inclination α of the lifting device 9 to change the vertical lifted-out state while maintaining the current inclination α within a predefinable or predefined range Δα for an inclination deviation.

The calculation can be effected, for example, by a computing unit 16 of the controller 5, and calculated control commands can be stored in a storage unit 17 of the controller 5.

In an actuation operating mode of the controller 5 the drives of the supporting legs 1, 2 of the support system can be actuatable using the sequence of control commands for changing the vertical lifted-out state of the lifting device 9 relative to the piece of ground 10, wherein, using the sequence of control commands, a sequential and time-limited actuation of the drives of the supporting legs 1, 2 of the support system 7 can be effected using control pulses s1, s2, s3.

Control commands stored in a storage unit 17 of the controller 5 can be output by the controller 5 in accordance with the sequence.

The longitudinal extent of the supporting legs 1, 2 can generally be made larger and/or smaller when the drives of the supporting legs 1, 2 of the support system 7 are actuated.

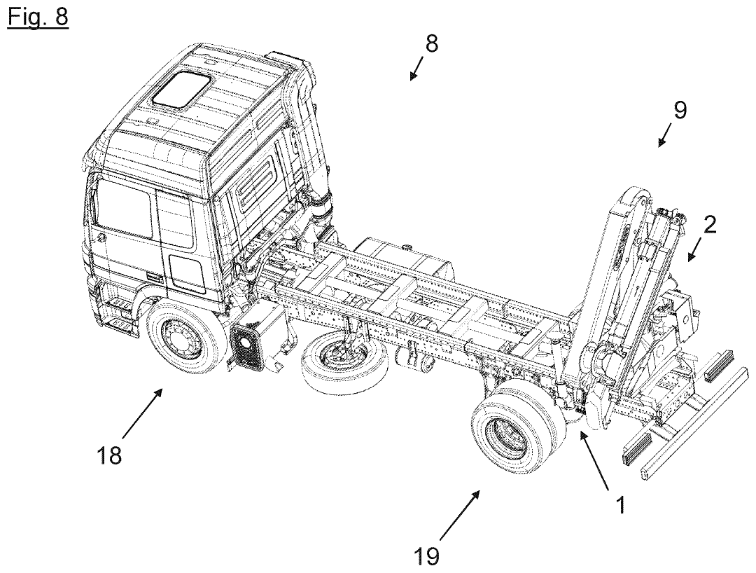

FIG. 8 shows a support device 7 analogous to the embodiment of FIG. 7 and arranged on a carrier vehicle 8 with lifting device 9.

Lifting out, using a support system 7 (cf. FIG. 3 or FIG. 7), relative to a spatial direction H (horizontal) predefined by way of example is shown schematically in FIGS. 9a to 9d. The support system 7 can be connected to a carrier vehicle, not represented in this figure, and/or a lifting device (swivel axis 15).

For it to be allowable for a lift-out method step ii to be carried out, it can for example be predefined that the currently detected inclination α of the carrier vehicle 8 and/or of the lifting device 9 is in a range of from 0° to 5° with respect to the horizontal H. An example range Δα for an inclination deviation of the detected inclination α of 5° with respect to the horizontal H is drawn in on both sides of the horizontal H in FIGS. 9a to 9d. It can thus be stipulated that the currently detected inclination α, as represented by way of example, is between +5° and −5° with respect to the horizontal H for carrying out the method.

The orientation represented in FIGS. 9a to 9d can correspond, with reference to FIG. 6, to a leveling about a longitudinal axis x and also to a leveling about a transverse axis y. Orientations relative to other r axes or spatial planes can be effected analogously.

The support system 7 has two supporting legs 1, 2 arranged on length-adjustable supporting arms 11, 12 in the embodiment shown. The supporting legs 1, 2 are length-adjustable in terms of their longitudinal extent. The supporting legs 1, 2 used for the orientation in this sequence of figures have, as represented, different (adjustable) longitudinal extents x11, x12, x13, x21 and x22. A lifted-out state can be characterized, for example, by these longitudinal extents and/or a distance measurement from the piece of ground 10.

It is not to be ruled out that, unlike what is represented, the support system 7 has several supporting legs (for example four) and that several of these supporting legs are also used for the orientation, in particular relative to a spatial plane. However, for presentation reasons, the procedure is restricted to two supporting legs 1, 2.

FIG. 9a shows a support system 7 supported on an inclined piece of ground 10, wherein the supporting legs 1, 2 have been brought into contact with the piece of ground. The direction of view can correspond to a view along a longitudinal axis of a carrier vehicle. The supporting legs 1, 2 in each case have a first longitudinal extent x11, x21. The inclination meter 6 outputs an inclination angle α of −2° measured with respect to the horizontal H.

Through the actuation of the drives of the supporting legs 1 using control pulses s1, s2, s3 which are sequentially output by the controller 5 and time-limited (see FIGS. 10a and 10b), a lifted-out state of the lifting device 9 can be incrementally changed, as represented enlarged.

In a calculation method step i (see FIG. 1), starting from the respectively measured inclination α, a sequence of control commands for the sequential and time-limited actuation of individual drives of the supporting legs 1, 2 of the support system 7 can be calculated for changing the lifted-out state while maintaining the inclination α within a range Δα for an inclination deviation. A partial change in the lifted-out state, such as is represented by way of example from one figure of FIGS. 9a to 9d to another, can be a part of the total desired or required change in the lifted-out state of the carrier vehicle or of the lifting device.

In FIG. 9b, the supporting leg 1 has a second, larger longitudinal extent x12 after actuation by the controller 5 using a control pulse s1. The inclination meter 6 outputs an inclination angle α of 2° measured with respect to the horizontal H, thus the inclination α has been maintained within the predefined range Δα for an inclination deviation.

This can correspond, for example, to a first pass through the calculation method step i and the lift-out method step ii.

A repetition of the calculation method step i and of the lift-out method step ii can be effected in loops iii (see FIG. 1). In each case, control commands—and thus control pulses and possibly overlaps—for the supporting legs 1, 2 can be calculated and actuations of their drives can be effected using control pulses.

In FIG. 9c the supporting leg 2 has a second, larger longitudinal extent x22 after a pass through the loop iii and actuation effected in the process by the controller 5 using a control pulse s2. The inclination meter 6 again outputs an inclination angle α of −3° measured with respect to the horizontal H. Although the inclination α has been made larger again relative to the shown spatial direction H, it is still in the range Δα for an inclination deviation.

With reference to FIG. 6, it can be noted that an orientation about the longitudinal axis x can also be effected through a change in the longitudinal extents of the supporting legs 1 and 2. Through the longitudinal extents of the supporting legs 1, 2, a change in the inclination about the transverse axis y can also be effected. With reference to a horizontal spatial plane, the inclination relative to a spatial direction situated therein (for example seen orthogonal to the spatial direction H) can also be maintained within a range for an inclination deviation.

In further passes through the loop iii (see FIG. 1) in each case a further repetition of the calculation method step i and of the lift-out method step ii can be effected to further change the lifted-out state. During each repetition of the loop iii, a sequence of control commands and corresponding control pulses, and possibly overlaps of control pulses, can be calculated for changing the vertical lifted-out state substantially while maintaining the current inclination α and the sequence of control commands can be implemented.

In FIG. 9d, the longitudinal extent x13 of the supporting leg 1 has been made incrementally larger in a further pass through the loop iii. The inclination meter 6 outputs an inclination angle xx of 0° measured with respect to the horizontal H.

It can be seen in FIG. 9d, with reference to the drawn-in longitudinal extents x11, x13, x21, x22 of the supporting legs 1, 2, that a substantially identical change in the longitudinal extents of all actuated supporting legs 1, 2 has been brought about by the sequence of control commands s1, s2, s3. It was thus possible to achieve a maintenance of the current inclination xx within a predefinable or predefined range Δα for an inclination deviation.

If the inclination α currently detected in a calculation method step i is outside the range Δα for an inclination deviation, a leveling of the carrier vehicle 8 and/or of the lifting device 9 can be effected by an embodiment of at least one leveling calculation method step v as described previously and of at least one leveling method step vi as described previously.

The sequence of FIGS. 9c to 9d can represent, as described, three repetitions of the loop iii, during which the longitudinal extent of the supporting legs 1, 2 is changed stepwise to change the vertical lifted-out state.

However, it is also conceivable that the sequence of FIGS. 9c to 9d corresponds to a single pass through the calculation method step i and the lift-out method step ii. The sequence of control commands can comprise the control pulses s1, s2, s3.

The changing of the vertical lifted-out state can be effected incrementally:
until the vertical lifted-out state of the carrier vehicle 8 and/or of the lifting device 9 reaches or falls below a predefined or predefinable target value, or
so long as an operating command for changing the vertical lifted-out state is provided by a user via a user interface 21 of a controller 5.

FIGS. 10a and 10b in each case show a schematic representation of three successive control pulses s1, s2, s3 with pulse duration t1, t2, t3, wherein the sequential control pulses s1, s2, s3 in FIG. 10b have a temporal overlap d.

Through an actuation, as illustrated for example in FIGS. 9a to 9d, of the drives of the supporting legs 1 using control pulses s1, s2, s3 which are sequentially output by the controller 5 and time-limited, a changing of the vertical lifted-out state of a carrier vehicle 8 and/or of a lifting device 9 while maintaining the current inclination α within a predefinable or predefined range Δα can be effected.

In FIG. 9b the supporting leg 1 has a larger longitudinal extent x12 compared with the representation in FIG. 9a after actuation by the controller 5 using a first control pulse s1 with pulse duration t1. In FIG. 9c the supporting leg 2 has a larger longitudinal extent x22 compared with the representation in FIG. 9b after actuation by the controller 5 using a second control pulse s2 with pulse duration t2. In FIG. 9d the supporting leg 1 has larger longitudinal extent x12 compared with the representation in FIG. 9a after actuation by the controller 5 using a third control pulse s3 with pulse duration t3. The actuation can be effected, for example, using control pulses s1, s2, s3 according to FIG. 10a.

Control pulses s1, s2, s3 succeeding one another in the sequence of control commands can also be simultaneously output by the controller in sections, thus for the duration of an overlap d.

Thus, for example, according to FIG. 10b, the activation of a drive for example of the supporting leg 1 for the pulse duration t1 of the control pulse s1 can be started first. Before the ongoing control pulse s1 ends, the activation of the drive of the next supporting leg 2 can already be started with the output of the control pulse s2 sequentially following according to the calculated sequence.

The time-limited, predefined or predefinable duration of the overlap d can determine the duration of an activation, simultaneous in sections, of drives of supporting legs 1, 2.

### LIST OF REFERENCE NUMBERS

1 supporting leg
2 supporting leg
3 supporting leg
4 supporting leg
5 controller
6 inclination sensor
7 support system
8 carrier vehicle
9 lifting device
10 piece of ground
11 supporting arm
12 supporting arm
13 supporting arm
14 supporting arm
15 crane column swivel axis
16 computing unit
17 storage unit
18 carrier vehicle front axle
19 carrier vehicle rear axle
20 mobile remote control
21 user interface
α inclination
Δα range for inclination deviation
i calculation method step
ii lift-out method step
iii repetition loop
iv monitoring method step
v leveling calculation method step
vi leveling method step
vii repetition loop
H horizontal
x longitudinal axis
y transverse axis
x11, x12, x13,
x21, x22 supporting legs longitudinal extent
s1, s2, s3 control pulse
t1, t2, t3 pulse duration
d overlap

1. A method for changing the vertical lifted-out state of a carrier vehicle, parked on a piece of ground, for a lifting device with a support system, wherein the support system includes:
supporting legs, vertically adjustable in terms of their longitudinal extent, for supporting on the piece of ground, and
a controller for actuating drives of the supporting legs using control commands;
wherein the method comprises:
at least one calculation method step in which a sequence of control commands for the sequential and time-limited actuation of the drives of the supporting legs of the support system is calculated for changing the vertical lifted-out state while maintaining the current inclination of the carrier vehicle and/or of the lifting device relative to at least one predefined or predefinable spatial direction and/or spatial plane within a predefinable or predefined range for an inclination deviation;
at least one lift-out method step in which an actuation of the drives of the supporting legs of the support system is effected using the sequence of control commands for changing the vertical lifted-out state of the carrier vehicle and/or of the lifting device relative to the piece of ground, wherein, using the sequence of control commands, a sequential and time-limited actuation of the drives of the supporting legs of the support system is effected using control pulses.

2. The method according to claim 1, wherein, in a calculation method step, a calculation of the sequence of control commands is effected on the basis of at least one parameter of the support system, wherein:
a detection of a current inclination as a parameter of the support system is effected with at least one inclination sensor of the support system for the detection of an inclination of the carrier vehicle and/or of the lifting device relative to at least one predefined or predefinable spatial direction and/or spatial plane, and in a calculation method step a calculation of the sequence of control commands is effected on the basis of a currently detected inclination of the carrier vehicle and/or of the lifting device, and/or
at least one parameter of the drives of the supporting legs is predefined or predefinable as a parameter of the support system, and in a calculation method step a calculation of the sequence of control commands is effected on the basis of the at least one parameter of the drives of the supporting legs, wherein preferably a lifting rate and/or a piston area of a drive formed as a hydraulic cylinder is predefined or predefinable as a parameter of the drives of the supporting legs.

3. The method according to claim 1, wherein the at least one parameter of the support system comprises at least one of the following:
parameters of the drives of the supporting legs, preferably lifting rates, piston diameters, piston areas, pumping power and/or electrical power,
parameters of the geometry of the supporting legs, preferably the prevailing or possible longitudinal extent, or a length of extension arms with supporting legs of the support system,
parameters of the position of the supporting legs,
the number of supporting legs,
an inclination of the carrier vehicle and/or of the lifting device currently detected with at least one inclination sensor of the support system, and/or
a predefinable or predefined range for an inclination deviation,
a currently predefined pulse duration of a control pulse, for example calculated in a preceding calculation method step,
a number and/or position of axles of the carrier vehicle,
a position of a lifting device arranged on the carrier vehicle,
a torsional and bending stiffness and/or a twisting of the carrier vehicle,
a predefined or predefinable spatial direction (H) and/or spatial plane,
a position, in particular a nominal position, of the center of gravity of the carrier vehicle and/or of the lifting device,
a load acting on a supporting leg, preferably by detection of a hydraulic pressure in a drive of a supporting leg and/or by a load sensor,
at least one parameter of the actuation of the drives of the supporting legs, preferably a control behavior of hydraulic valves of the hydraulic supply system of hydraulic drives and/or a switching behavior of energy supply systems of electrical drives,
a vertical distance, detected by at least one distance sensor of the support system, of the carrier vehicle and/or of the lifting device relative to a piece of ground used for the supporting.

4. The method according to claim 1, wherein an actuation of the drives of the supporting legs of the support system is effected
until the vertical lifted-out state of the carrier vehicle and/or of the lifting device reaches or falls below a predefined or predefinable target value, or
so long as an operating command for changing the vertical lifted-out state is provided by a user via a user interface of a controller.

5. The method according to claim 1, wherein:
in a calculation method step a sequence of control commands for changing the vertical lifted-out state of the carrier vehicle and/or of the lifting device is calculated for all drives of the supporting legs of the support system involved in the supporting,
in a lift-out method step at least one actuation of all drives of the supporting legs of the support system is effected using the sequence of control commands for changing the vertical lifted-out state of the carrier vehicle and/or of the lifting device.

6. The method according to claim 1, wherein a detection of an inclination of the carrier vehicle and/or of the lifting device relative to the horizontal is effected with an inclination sensor of the support system and a lift-out method step is carried out only if the inclination of the carrier vehicle and/or of the lifting device currently detected in a calculation method step is in a predefinable or predefined range for an inclination deviation of from 0° to 10°, preferably within 0° to 5°, particularly preferably within 0° to 3°, with respect to the horizontal.

7. The method according to claim 1, wherein the predefinable or predefined range for an inclination deviation is within 0° to 10°, preferably within 0° to 5°, particularly preferably within 0° to 3°, with respect to the horizontal.

8. The method according to claim 1, wherein in a loop, in a calculation method step which follows a lift-out method step carried out beforehand, a detection of the change in the inclination due to the preceding lift-out method step is effected.

9. The method according to claim 1, wherein the time-limited actuation of the individual drives of the supporting legs of the support system using the sequence of control commands is effected using control pulses with variable pulse duration.

10. The method according to claim 9, wherein the pulse duration of the control pulses is 0.05 seconds to 3.50 seconds, preferably 0.25 seconds to 1.5 seconds.

11. The method according to claim 9, wherein a variation of the pulse duration—and possibly of a temporal overlap between successive control pulses—is effected depending on:
parameters of the drives of the supporting legs, and/or
parameters of the geometry of the supporting legs, and/or
parameters of the position of the supporting legs, and/or
the number of supporting legs, and/or
the inclination of the carrier vehicle and/or of the lifting device currently measured with at least one inclination sensor of the support system, and/or
the predefinable or predefined range for an inclination deviation, and/or
the currently predefined pulse duration, and/or
the position of axles of the carrier vehicle, and/or
the position of a lifting device arranged on the carrier vehicle, and/or
a torsional and bending stiffness and/or a twisting of the carrier vehicle, and/or
a predefined or predefinable spatial direction and/or spatial plane, and/or
a position of the center of gravity of the carrier vehicle and/or of the lifting device, and/or
a load acting on a supporting leg and detected by detection of a hydraulic pressure in a drive of a supporting leg and/or a load acting on a supporting leg and detected by a load sensor,
at least one parameter of the actuation of the drives of the supporting legs, preferably a control behavior of hydraulic valves of the hydraulic supply system of hydraulic drives and/or a switching behavior of energy supply systems of electrical drives.

12. The method according to claim 1, wherein the actuation of the drives of the individual supporting legs of the support system using the sequence of control commands is effected in an actuation sequence in a predefinable or predefined order.

13. The method according to claim 1, wherein the actuation of the individual drives of the supporting legs of the support system using the sequence of control commands is effected using control pulses with a time-limited, predefined or predefinable overlap between successive control pulses.

14. The method according to claim 1, wherein within the overlap between successive control pulses a simultaneous actuation of at most two drives is effected.

15. The method according to claim 1, wherein the duration of the overlap between successive control pulses is between 0.01 seconds and 0.5 seconds, preferably between 0.01 seconds and 0.1 seconds.

16. The method according to claim 1, wherein a detection of the current inclination is effected with at least one inclination sensor of the support system for the detection of an inclination of the carrier vehicle and/or of the lifting device relative to at least one predefined or predefinable spatial direction and/or spatial plane, and after changing of the vertical lifted-out state of the carrier vehicle and/or of the lifting device has been effected a continuous detection of an inclination of the carrier vehicle and/or of the lifting device relative to at least one predefined or predefinable spatial direction and/or spatial plane is effected in a monitoring method step.

17. The method according to claim 16, wherein when the detected inclination reaches or exceeds a predefined or predefinable deviation, to minimize the inclination of the carrier vehicle and/or of the lifting device,
in a leveling calculation method step a sequence of control commands for the sequential and time-limited actuation of individual drives of the supporting legs of the support system is calculated on the basis of a currently detected inclination of the carrier vehicle and/or of the lifting device,
in a leveling method step an actuation of the drives of the supporting legs of the support system is effected using the sequence of control commands for reducing the inclination of the carrier vehicle and/or of the lifting device relative to at least one predefined or predefinable spatial direction and/or spatial plane, wherein, using the sequence of control commands, a sequential and time-limited actuation of individual drives of the supporting legs of the support system is effected using control pulses.

18. A computer program product comprising commands which, when executed by a computing unit, prompt the latter to execute the method according to claim 1 from a storage unit which is in or can be brought into data connection with the computing unit.

19. A controller for controlling a support system and configured to carry out the method according to claim 1, wherein the controller is configured to:
perform a calculation operating mode in which a sequence of control commands for the sequential and time-limited actuation of individual drives of the supporting legs of the support system is calculable for changing the vertical lifted-out state while maintaining the current inclination within a predefinable or predefined range for an inclination deviation, and
perform an actuation operating mode in which the drives of the supporting legs of the support system are actuatable using the sequence of control commands for changing the vertical lifted-out state of the carrier vehicle and/or of the lifting device relative to the piece of ground, wherein, using the sequence of control commands, a sequential and time-limited actuation of the drives of the supporting legs of the support system is effected using control pulses.

20. A vehicle comprising:
a lifting device;
a support system; and
the controller according to claim 19.
